(19) United States
(12) Patent Application Publication
(10) Pub. No.: US 2003/0010421 A1
(43) Pub. Date: Jan. 16, 2003

(54) Method for fabricating structural materials from used tires

(76) Inventors: Joseph H. Coffin, La Verne, CA (US); Jerry D. Coffin, Guilderland, NY (US)

Correspondence Address: HESLIN ROTHENBERG FARLEY & MESITI PC, 5 COLUMBIA CIRCLE, ALBANY, NY, 12203, US

(21) Appl. No.: 09/904,139

(22) Filed: Jul. 11, 2001

(51) Int. Cl. B32B 1/00; B32B 31/00

(52) U.S. Cl. 156/95; 156/256; 156/264; 156/245

(57) ABSTRACT

A process for fabricating cord-reinforced-rubber structural materials from used tires and a cord-reinforced-rubber structural material. The process includes the following steps for handling and treating the tires: removing the side walls from the tires; removing at least some of the tread material from the tire to provide an essentially uniform tread thickness; cutting the tires in a transverse direction to provide elongated strips of tire material having at least some inherent curvature; removing at least some of the inherent curvature by compressing the strips to at least about 100 psi and heating the strips to at least 200 degrees F to remove at least some of the inherent curvature; mating the strips with a gum rubber adhesive; and bonding the strips and gum rubber adhesive by compressing them to about 100 psi and heating them to at least 200 degrees F. By removing at least some of the inherent curvature the strips of rubber material are more easily handled during subsequent processing. The structural materials produced typically take the form of boards and planks, but may used for fabricating other structures such as panels, walls, and bulkheads, among other things.

### TECHNICAL FIELD

This invention relates generally to apparatus and methods used to fabricate structural materials from vehicle tires, for example, used vehicle tires. Specifically, the present invention provides improved methods and apparatus for fabricating rubber structural boards, planks, posts, beams, etc. from used tires.

### BACKGROUND OF THE INVENTION

Used tires, from the small ones used on recreational vehicles, to the typical passenger car tires, to the behemoths used for large earth moving vehicles, are the undesirable by-products of the commercial success of the tire industry in the late 20^{th} century and early 21^{st} century. The modern tire is a highly-engineered product. For example, in the case of passenger car tires, they are designed and built to withstand tens of thousands of driving miles, under diverse driving conditions, and the innumerable obstacles that they can encounter on the modern highway. However, the limited useful life of these tires and their relative indestructibility is evidenced by both the individual discarded tire on the side of the road and the large tire piles that blight the landscape. Unfortunately, due to their indestructibility, used tires present both environmental and health hazards. Tire pile fires present dramatic evidence of the impact used tires can have on our environment. Used tires also provide breading sites for pests and vermin. There are an estimated 1 billion tires scrapped around the world every year; 270 million tires are scrapped in the United States alone. Clearly, there is a need to somehow make a viable product from these highly-engineered materials.

Numerous attempts have been made to salvage and re-use the tires themselves or the materials from which they are composed. Tire re-treading is a common practice for both commercial and passenger tires, but though commonly accepted in the commercial trucking industry, re-treads have met with limited acceptance in the passenger tire market. In addition, some essentially unaltered used tires are used for structural barriers or supports. Tires are also ground up to recover the rubber material, for example, as “crumb rubber”. Crumb rubber can be used for assorted purposes, including recycled by the tire manufacturers into new tires. However, the presence of non-rubber reinforcing materials in the tires, for example, steel or fiberglass belts, makes such recycling difficult, and as result the wholesale recovery of crumb rubber has met with limited success.

In a process pioneered independently by Snyder and Coffin, as described in U.S. Pat. No. 5,096,772 and co-pending U.S. applications Ser. Nos. 08/031,224 filed Mar. 12, 1993 (now U.S. Pat. No. ______) and 09/794,581 filed on Feb. 27, 2001, (the entire disclosures of which are incorporated by reference herein) used tires are treated to fabricate structural materials, for example, reinforced rubber boards, posts, and beams, among other things. These structural materials incorporate the beneficial properties of the parent steel-reinforced tires, that is, non-toxicity, flexibility, strength, and endurance, and insusceptibility to chemical or biological degradation, that make the resulting products ideal for structural applications, such as a replacement for lumber. However, though the processes disclosed by Snyder and Coffin provide commercially successful products, further improvements to these processes provide stronger more integrally sound products, which can be more readily and more cost-effectively manufactured. The present invention provides improvements to the prior art processes.

### SUMMARY OF THE INVENTION

The present invention provides methods and apparatus which address many of the limitations of prior art methods and apparatus. One aspect of the present invention is a method for fabricating structural materials from tires, the method comprising: removing side walls from the tires; cutting the tires in a transverse direction to provide elongated strips of tire material having at least some inherent curvature; treating the strips to remove at least some of the inherent curvature; mating at least two of the strips with an adhesive; and bonding the strips and adhesive to produce the structural material. In one aspect of the invention, the adhesive used is gum rubber, for example, extruded gum rubber. The treating of the strips to remove at least some of the curvature is typically practiced by compressing and heating the strips. The compressing is typically practiced to provide a pressure of at least 100 psi and the heating is typically practiced at greater than 100 degrees F., and the heating is more typically practiced at greater than 200 degrees F. The bonding process is also typically practiced by compressing and heating the strips and adhesive under similar conditions. In one aspect of the invention, the bonding is practiced distinct from the step of treating the strips to remove at least some of the inherent curvature.

Another aspect of the present invention is a structural member, fabricated from tires, by a method comprising: removing side walls from the tires; cutting the tires in a transverse direction to provide elongated strips of tire material having at least some inherent curvature; treating the strips to remove at least some of the inherent curvature; mating at least two of the strips with an adhesive; and bonding the strips and adhesive to produce the structural member. The structural member may take the form of a plank, a board, a beam, a rod, a tube, an arch, a column, a post, a stud, roofing, and flooring, among others. The treating to remove at least some inherent curvature typically comprises compressing and heating the strip. Again, the compressing is typically practiced to provide a pressure of at least 100 psi and the heating is typically practiced greater than 100 degrees F. The bonding step also typically comprises compressing and heating the strips and adhesive. Again, in one aspect of the invention, the bonding is practiced distinct from the step of treating the strips to remove at least some of the inherent curvature. Also, again, in one aspect of the invention, the adhesive used is gum rubber.

A further aspect of the present invention is a method for fabricating structural materials from tires, the method comprising: removing side walls from the tires by cutting the side walls at a point below the tread; removing at least some tread material from the tire to provide an essentially uniform tread thickness; cutting the tires in a transverse direction to provide elongated strips of tire material having at least some inherent curvature; removing at least some of the inherent curvature by compressing the strips to at least about 100 psi and heating the strips to at least 200 degrees F. to remove at least some of the inherent curvature; mating at least two of the strips with a gum rubber adhesive; and bonding the strips and gum rubber adhesive by compressing the strips and gum rubber adhesive to at least about 100 psi and heating the strips and gum rubber adhesive to at least 200 degrees F. to produce the structural material. The heating during removing at least some of the inherent curvature is practiced at between about 200 and about 300 degrees F. The removing of at least some of the tread material comprises an abrasion process. In a one aspect of the invention the steps of the method are practiced sequentially, that is, in the order listed. In one aspect of the invention, the bonding is practiced distinct from the step of treating the strips to remove at least some of the inherent curvature.

The present invention provides improved methods for fabricating structural materials from used tires and also improved fiber-reinforced rubber structural materials than those methods and materials compared to the prior art. The above aspects and other embodiments and aspects of the present invention will become more apparent upon review of the attached drawings, description, and claims.

### BRIEF DESCRIPTION OF DRAWINGS

The subject matter which is regarded as the invention is particularly pointed out and distinctly claimed in the concluding portion of this specification. The invention, however, both as to organization and method of practice, together with further objects and advantages thereof, may best be understood by reference to the following detailed descriptions of the preferred aspects and the accompanying drawings in which:

FIG. 1 is a schematic flow diagram of one aspect of the present invention.

FIG. 2 is side view of a typical tire that can be used for the present invention.

FIG. 3 is cross-sectional view taken along lines 3-3 of FIG. 2.

FIG. 4 is side view of the tire of FIG. 2 after side-wall removal.

FIG. 5 is a cross-sectional view taken along lines 5-5 of FIG. 4.

FIG. 6 is a cross-sectional view similar to FIG. 5 after buffing.

FIG. 7 is a side view of the tire of FIG. 4 after transverse cutting.

FIGS. 8A and 8B are schematic views of the pre-flattening step according to the present invention.

FIG. 9 is a side view of a pre-flattened rubber strip according to the present invention.

FIG. 10 is a side view similar to FIG. 9 with the application of an adhesive to the rubber strip.

FIG. 11 is schematic view of the stitching of two rubber strips according to the present invention.

FIG. 12 is a schematic view of the bonding process according to the present invention.

FIG. 13 is a perspective view of rubber board produced by the process of the present invention.

FIG. 14 is a perspective view of a rubber beam produced by the process of the present invention.

FIG. 15 is a perspective view of a tongue and groove construction according to the present invention.

FIG. 16 is a perspective view of a rubber bulkhead according to another aspect of the present invention.

### DETAILED DESCRIPTION OF DRAWINGS

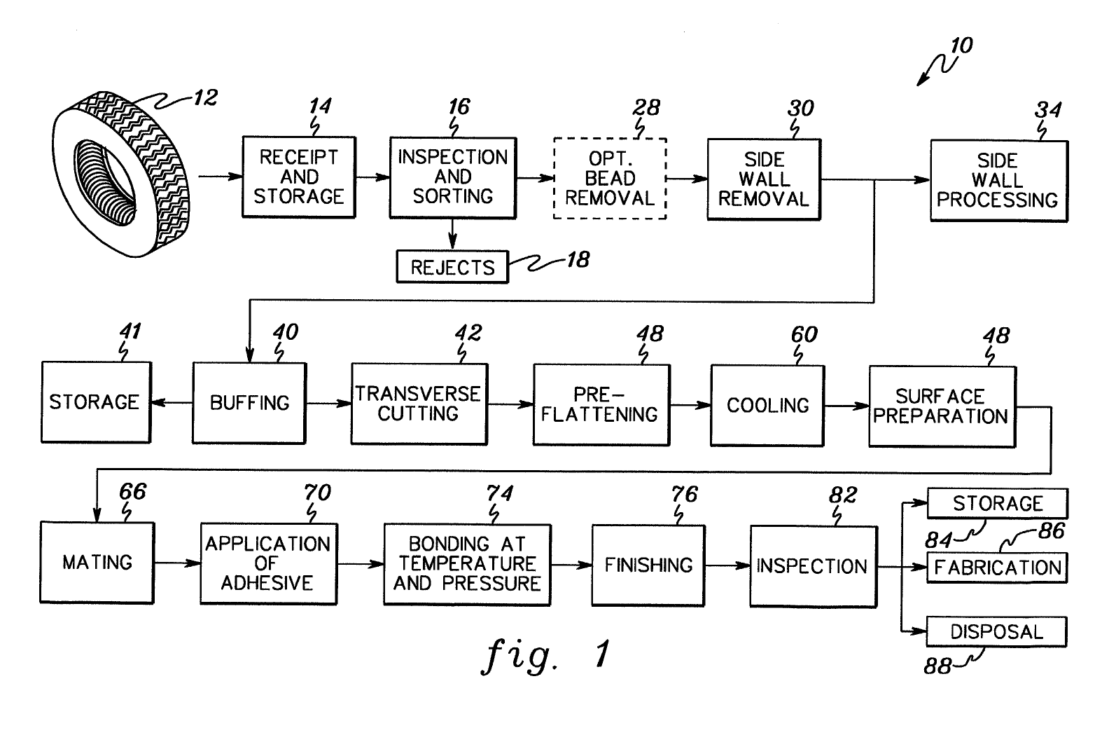

FIG. 1 is a schematic flow sheet illustrating one aspect of the present invention. According to this aspect of the invention, one or more tires 12, for example, used passenger car tires are received and stored 14. Tires 12 may be received from a tire provider or manufacturer, a waste material hauler, a municipal collection station, or from any other source of used tires. After receipt and storage 14, tires 12 are inspected and sorted 16 based upon size and physical condition. Tires having damaged or exposed treads are typically discarded 18, or otherwise treated to recover usable material.

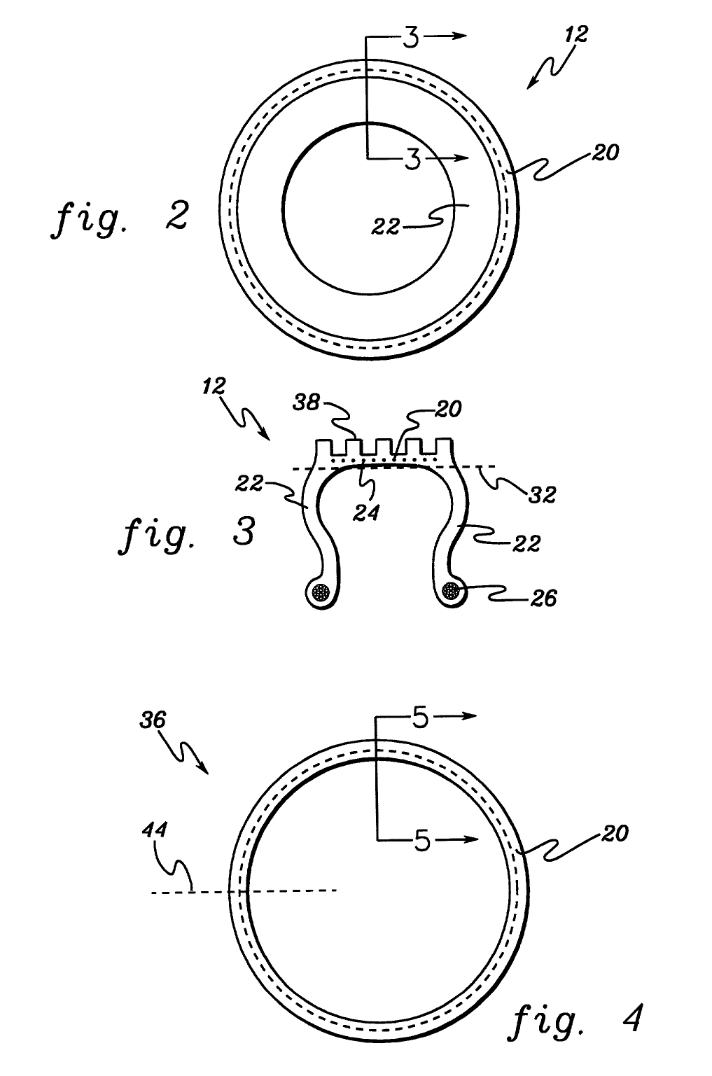

A typical tire 12 that is handled and processed according to the present invention is shown in FIG. 2. Tire 12 includes a tread portion 20 and two side walls 22. FIG. 3 is a cross-sectional view taken along line s 3-3 of FIG. 2. FIG. 3 illustrates the tread 20, the typical reinforcing cords 24 imbedded in tread 20, and the tread surface 38. Also shown in FIG. 3 are the typical reinforcing beads 26 that circle and reinforce the inside diameter of the side wall 22.

With reference to FIG. 1, after inspection and sorting 16, tires 12 may have their reinforcing beads 26 removed prior to further processing. The reinforcing bead is typically removed using a specially-designed bead removal device provided by the Voights Manufacturing Company of Streaton, Ill., though other types of similar equipment may be used.

After side wall bead removal 28 or after inspection and sorting 16, side walls 22 are removed 30 from tire 12. Sidewalls 22 are typically removed by slicing side walls 22 along the line 32 shown in FIG. 3. This may be done manually, but is preferably practiced using a specially-designed side wall cutting device, for example, one provided by the Engineering and Equipment Company of Scottsdale, Ariz., though other similar devices may be used. The removed side walls may be further processed 34, for example, the side walls 22 may be ground to recover their rubber content. Since side walls 22 are removed according to the present invention, side wall bead removal 28 is optional. If desired, bead removal 28 may be practiced according to the present invention to facilitate further treatment or processing of side walls 34.

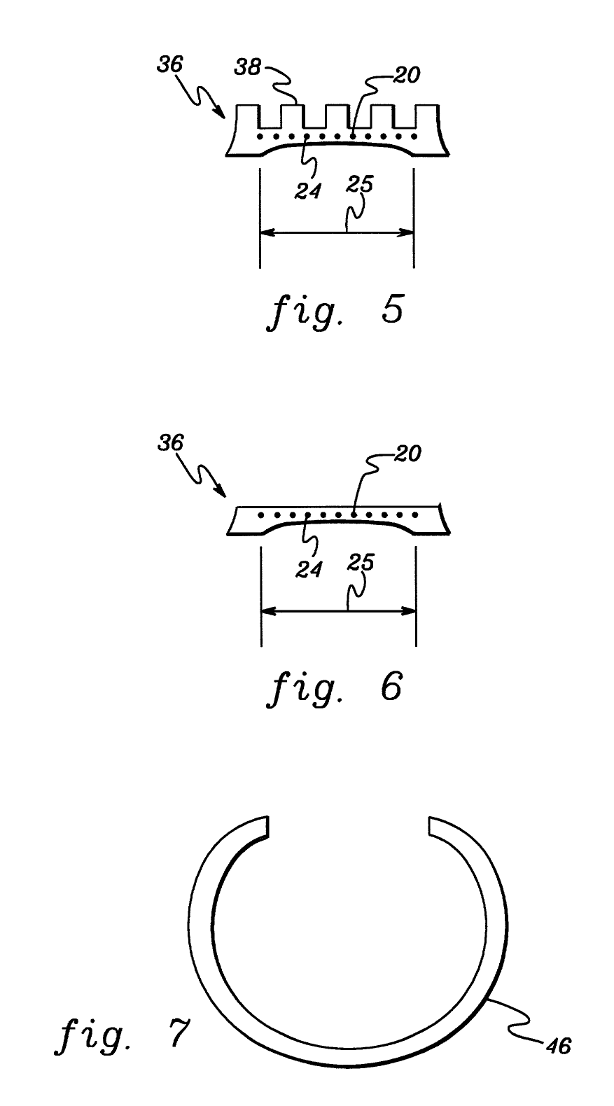

A side view of a tire 36 after side wall removal 30, is shown in FIG. 4. At this point in the process, the tire 36 is essentially only a circular tread 20. A cross sectional view of tire 36 taken along lines 5-5 of FIG. 4 is shown in FIG. 5. FIG. 5 illustrates the tire tread 36 having a tread 20 with reinforcing cords 24 and a tread surface 38. FIG. 5 also illustrates the width 25 of the cords 24.

With reference again to FIG. 1, after side wall removal 30, the tire 36 is treated to remove at least some of the tread surface 38 to provide a relative uniform tread thickness. This treatment is typically referred to as “buffing ” in the retread industry. This treatment is typically some form of abrading process in which the tread surface 38 is ground off. One preferred method of buffing the surface 38 is by using a specially-designed buffing device, for example, a device having a rasp-like grinding wheel provided by the Cincinnati Retread Company of Cincinnati, Ohio, though other similar devices may be used. After buffing 40, the tire 36 typically appears as shown in FIG. 6, that is, with the tread surface 38 removed to provide a relatively uniform tread thickness to the remaining tire 36. FIG. 6 also illustrates the width 25 of reinforcing cords 24. If desired, the tread removal or buffing step 40 may also be practiced prior to side wall removal 30.

After buffing 40, tire 36 is then transversely cut or sliced 42, for example, tire 36 is cut along dashed line 44 of FIG. 4, so that the tire unfolds as illustrated by the strip of cord-reinforced rubber 46 as shown in FIG. 7. Rubber strip 46 is typically about 5 to 6 feet long for a passenger car tire; the strip 46 may be longer or shorter depending upon the size of the original tire 12. The slicing or transverse cutting 42 may be practiced using a specially-designed tire cutting machine provided by the Engineering & Equipment Company, though other types of similar machines may be used, or the slicing may be done manually with a sharp implement. Note that rubber strip 46 typically has a cross-section as shown in FIG. 6. As shown in FIG. 7, rubber 46 typically also has some form of inherent curvature. This curvature is typically at least about two axis, for example, the curvature about the axis of the tire shown in FIG. 7 and the curvature about the axis of the strip 46 shown in FIG. 6. This inherent, typically dual, curvature can make the strip 46 difficult to handle both manually and via automated methods. However, according to one aspect of the present invention, before further processing, at least some of the inherent curvature of the strip 46 is removed to facilitate further handling.

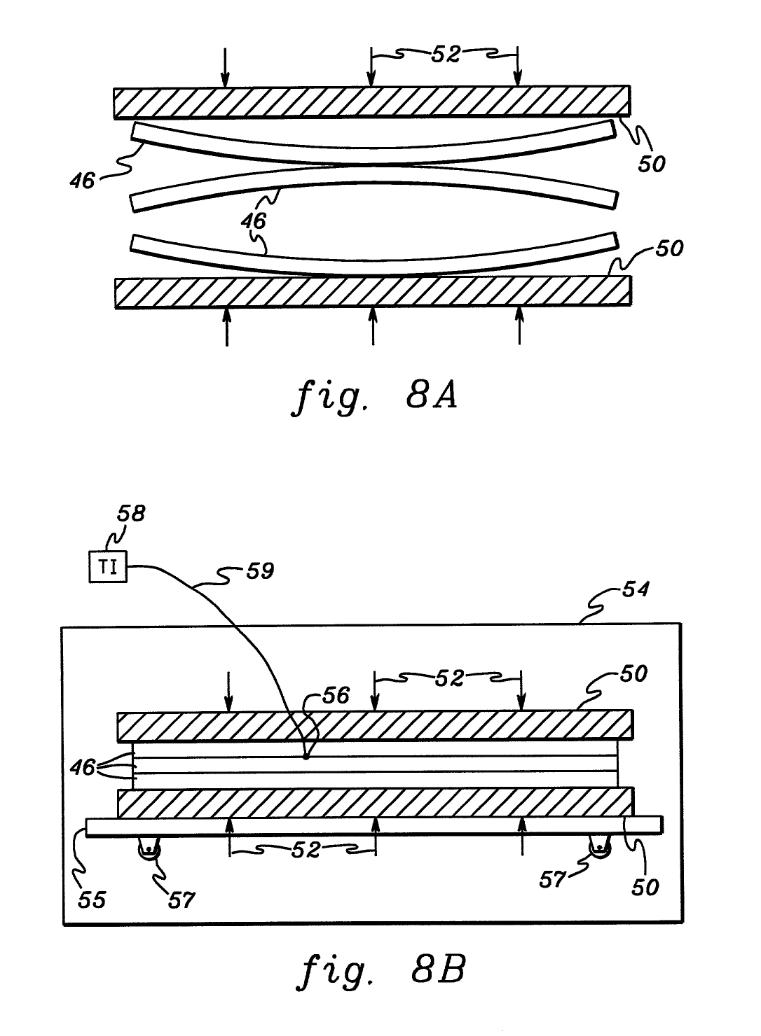

In order to facilitate further handling and processing, the rubber strip 46 of FIG. 7 is treated 48 (again with reference to FIG. 1) to remove at least some of the inherent curvature in strip 46. According to the present invention, this treatment 48 is a “pre-flattening”, that is, a flattening of tire 46 by exposing tire 46 to temperature and pressure. A schematic representation of a typical method and apparatus for effecting this pre-flattening treatment 48 are illustrated in FIGS. 8A and 8B. In FIG. 8A, one or more of the rubber strips 46 are positioned between two relatively rigid surfaces 50, for example, surfaces 50 may be two steel plates having a thickness of between about 0.0625 inches and about 1 inch and a length and width at least as great as the length and width of the strips 46, for example, the length of the plates 50 is about 8 feet and the width of the plates 50 is about 8 inches. Though only two plates 50 are shown in FIG. 8A, more than two plates may be used, for example, six, ten, or even more plates 50 may be used with one or more strips 46 positioned between plates 50. The assembled stack of rubber strips 46 and plates 50 is then compressed as indicated by arrows 52. The compression indicated by arrows 52 may be provided manually, mechanically (for example, by loading dead weights upon the stack, by clamping, by using come-alongs or other mechanical-advantage devices, including using a hydraulic or pneumatic press), or by any other conventional means of applying a compressive load on the stack of strips 46 and plates 50. The compression load on the strips 46 is typically at least about 50 pounds per square inch (psi), and is preferably between about 1000 psi and about 1500 psi.

After compression or during compression of the stack of strips 46 and plates 50, the assembly of plates and rubber strips are exposed to temperature for a specific time period as illustrated in FIG. 8B. In FIG. 8B, the stacked strips 46 and plates 50 are compressed as indicated by arrows 52 within an oven 54. Oven 54 may be any type of conventional commercial oven into which the assembly of strips 46 and plates 50 of FIG. 8A can be inserted. One type of oven that may be used to effect the desired heating is one provided by the Jensen Baking Company of Farmington, Mich., though other comparable ovens may be used. In order to facilitate inserting and removing the assembly of strips 46 and plates 50, the assembly is preferably mounted on a movable platform 55, for example, a dolly or cart having casters with wheels or rollers 57.

While in oven 54 the temperature of the oven and the temperature of the assembly of strips 46 and plates 50 are raised to a temperature at which at least some of the inherent curvature of the strips 46 is removed while under compression. The temperature to which the strips 46 are raised is typically at least 100 degrees F. and is at least 150 degrees F. For example, in a typical mode of heating, the temperature of the compressed strips is raised to between about 150 degrees F. and about 400 degrees F., and in a preferable mode of heating is heated to between about 200 degrees F. to about 300 degrees F. The compressed strips 46 are held at temperature for between about 10 minutes to about 90 minutes, or longer, typically for between about 10 minutes and about 30 minutes, and preferably about 10 minutes to about 20 minutes.

The temperature of the strips 46 may be monitored by some form of temperature sensing device 56 and monitoring device 58 during the pre-flattening stage 48. For example, one or more thermocouples, thermistors, or TRDs 56 may be positioned within the compressed stack of rubber strips 46 in order to monitor the temperature of the strips. The temperature signal from temperature sensing device 46 may be passed via a cable or wire 59 to a temperature indicating (TI) device 58 located outside the oven 54. Temperature indicator 58 can be monitored by a human operator, or by means of automated controller. For example, an automated controller can be used to monitor the time and temperature of treatment and adjust the temperature of oven 54 accordingly.

The pre-flattening step 48 may be effected manually by a human operator or may be effected automatically. For example, the insertion of the assembly of the strips 46 and plates 50 into oven 54 may be automated in which the strips 46 are introduced to the oven 54 by means of a conveyor and then the time and temperature of treatment in the oven 54 is monitored and controlled by an electronic controller. The electronic controller may be programmed to control the temperature of oven 54 to a predetermined schedule. The controller may receive temperature inputs from one or more temperature sensing devices 56.

With reference to FIG. 1, after the pre-flattening stage 48, the now flatter strips 64 are removed from oven 54 and allowed to cool 60, for example, to ambient temperature, to facilitate further handling. Cooling 60 may be practiced after disassembling the compressed stack of strips 46 and plates 50, or while the stack is still assembled. When the process is implemented via automation, for example, without the handling of the strips by human mechanics, the pre-flattened strips 46 may proceed to further processing without cooling.

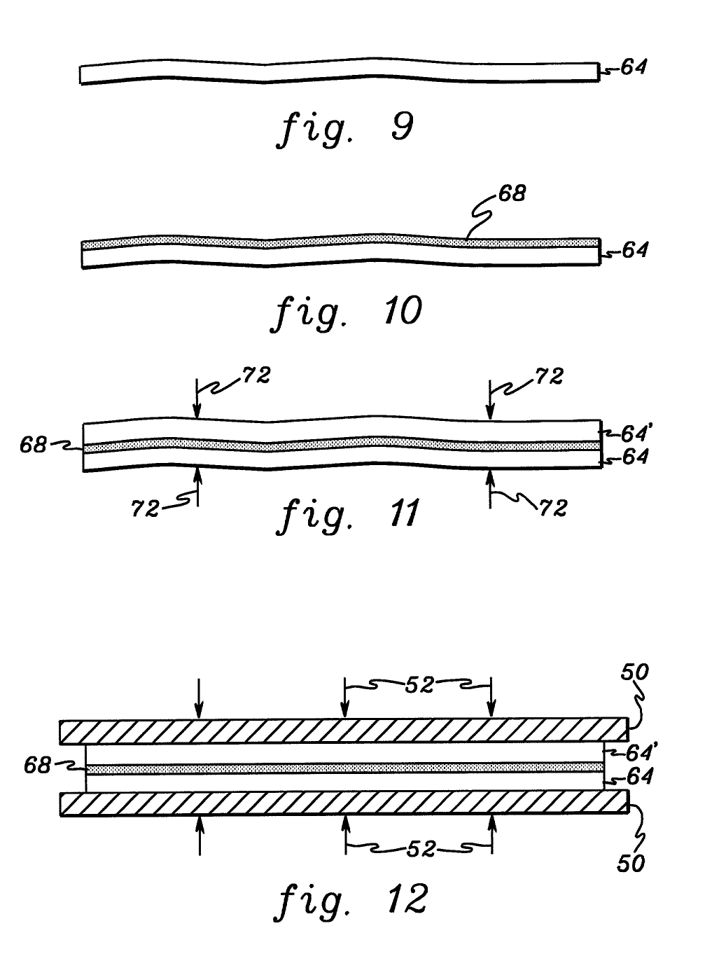

As shown in FIG. 9, the flatter rubber strips 64 (that is, strips 46 after treatment 48) are not necessarily completely flat, but strips 64 typically have at least some of their inherent curvature removed so that they can be more easily manually or automatically handled during further processing.

One preferred further processing of strips 64 is surface preparation 62 in preparation for bonding. Surface preparation 62 typically comprises some form of surface abrading process to provide a rougher surface to which an adhesive will more securely bond. One method of preparing the surface of the strips 64 is to wire brush at least one surface of strip 64. Again, the wire brushing process may be performed manually by a technician or effected automatically in a wire brushing device. After surface preparation 62, the surface of strip 64 may also be treated with a liquid adhesive or cement to further ensure adhesion during the bonding process. One adhesive that may be used is “Fiber Bond” spray-type cement provided by the Patch Rubber Company of Roanoke Rapids, N.C., though other types of adhesives may also be used.

After surface treatment 62, two of more strips 64, 64′ are mated 66 to provide compatible treads that will be bonded. For example, one criterion for mating 66 is to compare the reinforcing fiber width (25 in FIG. 6) between two strips 64, 64′. In order to ensure that the resulting structural member has structural integrity and to facilitate the finishing process, it is preferred that the width of the reinforcing fibers between two or more strips 64, 64′ are approximately the same. Anther criterion for mating strips is to compare, the over-all lengths of the strips 64, 64′. Strips 64, 64′ having comparable reinforcing fiber widths and comparable lengths are mated for bonding during subsequent processing.

The mated strips 64, 64′ are then prepared for bonding. First, as shown in FIG. 10, one of the strips 64 is laid flat and a layer of adhesive 68 is applied to one of its surfaces as indicated by 70 in FIG. 1. A preferred adhesive according to the present invention is an uncured rubber, for example, an uncured rubber referred to as “cushion gum” rubber. One preferred source of cushion gum rubber is the Patch Rubber Company, though other types of cushion gum rubber may also be used. In addition, other types of adhesives that may be used to bond the strips 64, 64′ for example, a specialty silicone adhesive, such as Du Pont® 5200 silicone adhesive. The adhesive 68 may be applied in the form of a fluid or liquid or solid, but is preferably applied in the form of strips having a removable backing. For example, in one mode of operation cushion gum is applied to the rubber strip 64 as strips of cushion gum cut from rolls of cushion gum. The adhesive may also be applied as an extrusion and may be applied hot or at ambient temperature.

After the adhesive is applied as shown in FIG. 10, the second mating rubber strip 64′ is applied on top of adhesive 68 as shown in FIG. 11. The assembly of strips 64, 64′ and adhesive 68 is lightly compressed to ensure thorough surface contact between adhesive 68 and strips 64, 64′ as indicted by arrows 72 in FIG. 11. This application of compression to the assembly of strips 64, 64′ and adhesive 68 is known in the art as “stitching”. This light pressing may be effected manually by a hand roller or automatically, for example, by means of an automated twin-roll press. The rubber strips 64, 64′ may be assembled with adhesive 68 in any appropriate manner, for example, tread-side-to-tread-side, tread-side-to-liner-side, or liner-side-to-line side. Although only two strips 64, 64′ are shown in FIG. 11, more than two strips 64, 64′ can also be assembled with multiple layers of adhesive 68 and bonded to more a multi-layer assembly.

With reference again to FIG. 1, after application of adhesive 70, the assembly of strips 64, 64′ and adhesive 68 is ready for bonding 74. The bonding step 74 is very similar to the pre-flattening step 48. In a manner similar to pre-flattening 48, one or more of the assemblies of strips 64, 64′ and adhesive 68 shown in FIG. 11 are mounted between two or more metal plates 50 as shown in FIG. 12. In the essentially same procedure practiced with respect to the pre-flattening step 48 and using essentially the same apparatus shown in FIG. 8B. The assembly of strips 64, 64′, adhesive 68 and plates 50 are compressed 52 and heated in an oven, for example, oven 54 in FIG. 8B. The amount of compression (for example, about 1500 psi), the temperature (for example, about 250 degrees F.) and time of treatment (for example, about 20 minutes) are essentially the same as those used in the pre-flattening step 48. However, unlike the pre-flattening step 48, the treatment in bonding step 74, may not only flatten the rubber strips 64, 64′, but the temperature is sufficient to cure the adhesive 68 and produce an effective bond between the rubber strips 64, 64′.

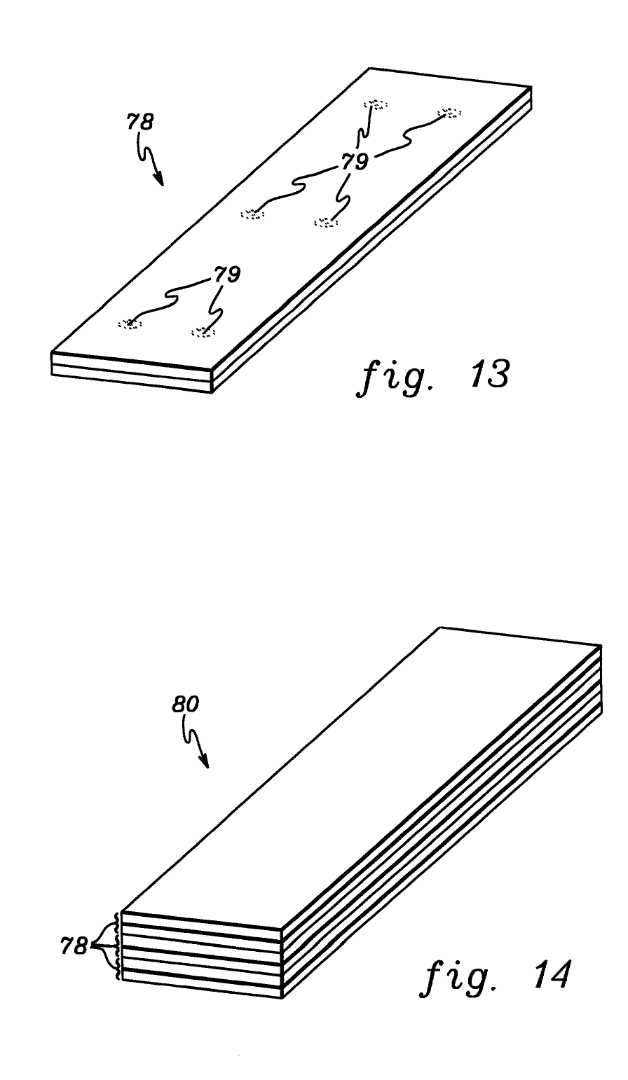

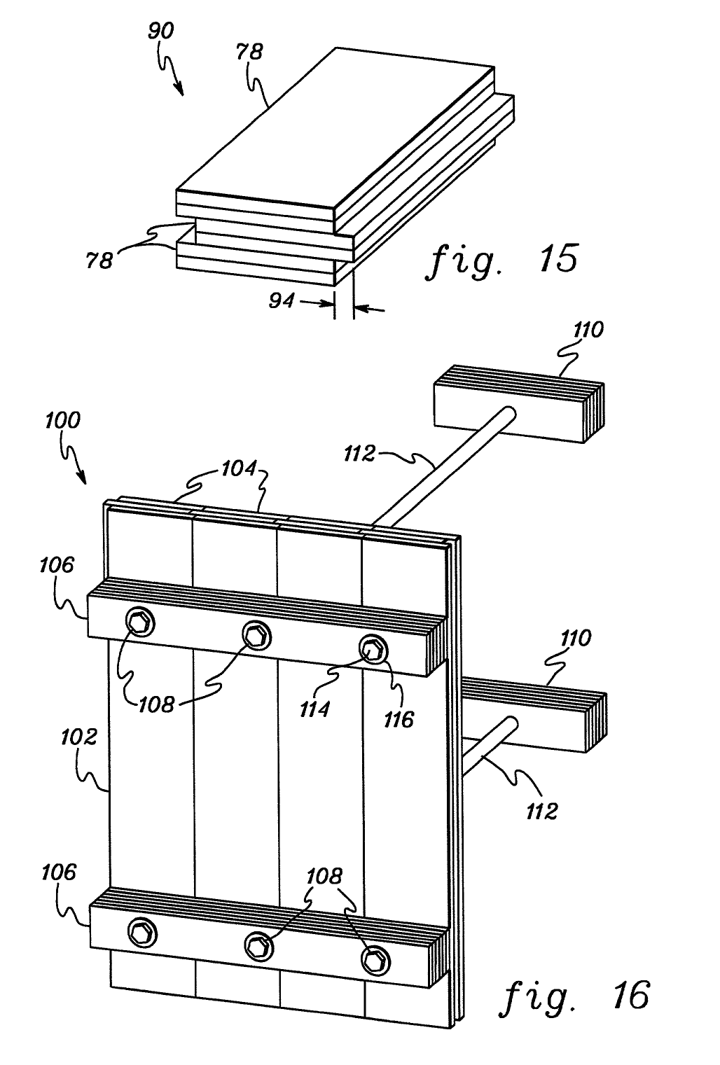

After bonding 74, the assembly of strips 64,64′ and plates 50 is removed form the oven and, if necessary, allowed to cool to ambient temperature to facilitate further handling. The bonded strips 64, 64′ may be finish machined 76 to size or to remove excess rubber. Finish machining may be performed by manual or automatic cutting, shearing, conventional table or band sawing, or water-jet cutting, among other processes. The essentially finished product 78, for example, a board, is shown in FIG. 13. For boards fabricated from passenger car tires, board 78 is typically about 5 to about 6 feet in length, about 5 to about 8 inches in width, and about one-half to 1 inch in thickness. The structural board illustrated in FIG. 13 is marketed under the trademark DURABOARD™ by Tire Conversion Technologies of Scotia, N.Y. The structural integrity of board 78 may be reinforced by placing one or more fasteners 79 (shown in phantom) into board 78, for example, one or more bolts or screws. One or more boards 78 may be further bonded in a manner similar to bonding 74 to provide further products, for example, a beam or post 80 shown in FIG. 14. Beam 80 is composed of three boards 78 shown in FIG. 13. Of course, the finished product may also be a plank, a rod, a tube, an arch, a column, or a stud, among others, depending on the number and size of the original strips 46 and the type of finish machining 76.

The finished product can be used as a replacement for lumber, in particular, as a replacement for chemically-treated lumber (for example, pressure-treated lumber). The finished product may be used for flooring, roofing, foundation protection, and marine applications, for example, as docking, decking, bulkheads, or barriers. Beam 80 may be used as a structural member or as a foundation, for example, as a railroad tie.

After finishing 76 the finished products or structural members 78 are inspected 82, for example, for bonding continuity, dimension, or other desired characteristic. Acceptable products may be forwarded to storage 84 or to further fabrication 86. Rejected products may be forwarded to disposal 88 and discarded or processed to recover usable materials, for example, ground and sold as crumb rubber.

One type of fabrication which can be made, for example, from structural members like board 78 in FIG. 13, is shown in FIG. 15. FIG. 15 illustrates a perspective view of a tongue-and-groove-type panel 90 fabricated from three boards 78. Panel 90 is constructed by applying an adhesive between boards 78 and assembled so that middle board is off-set a distance 94 to provide the tongue-and-groove configuration. The application and bonding of boards 78 is typically practiced by steps 70, 74, and 76 shown in FIG. 1, and described above. Panel 90 may also be constructed using mechanical fasteners, for example, bolts or screws. Panel 90 may be constructed from two or more boards 78. Panel 90 is typically assembled with similar panels as is typical of conventional tongue-and-groove construction. An appropriate adhesive, for example, Du Pont® 5200 silicone adhesive, may be applied to the mating surfaces between the “tongue” and “groove” of the boards to provide a rigid construction, or panels 90 may be assembled with mechanical fasteners, for example, bolts or screws.

Another type of construction that can be fabricated from boards 78, beams 80, and panels 90 is illustrated in FIG. 16. FIG. 16 illustrates a bulkhead 100 that can be used as a retaining wall for landscaping or for waterfronts. FIG. 16 illustrates only one section of a barrier that maybe comprised of one or more bulkheads 100. Bulkhead 100 is comprised of a vertical wall section 102 which is comprised of tongue-and-groove-type panels 104, that is, panels similar to panel 90 shown in FIG. 15, and cross-beams 106, similar to beams 80 shown in FIG. 13. Wall section 102 may be made from two or more panels 104 and one or more cross-beams 106. An adhesive may be applied to the mating surfaces of panels 104 and to the mating surfaces of panels 104 and beams 106. In addition to or in lieu of an adhesive, beams 106 may be attached to panels 106 by mechanical fasteners 108, for example, nuts and bolts or screws.

In one preferred mode of assembly, when two or more walls 102 are assembled into, for example, a bulkhead 100, the beams 106 can be attached to panels 104 by overlapping one or more beams 106 across two or more wall sections 102 in order to provide more structural stability. Further structural stability is provided by staggering beams 106 such that one beam, for example, the top beam shown in FIG. 16, straddles one wall section 102 and an adjacent section 102, and another beam 106, such as the bottom beam shown in FIG. 16, straddles one wall section 102 and another adjacent wall section 102.

Wall section 102 may be supported by any appropriate means. For example, wall section 102 may be supported by diagonal struts (not shown) mounted against the front or back of wall section 102, or wall section 102 may be supported by vertical columns or rods inserted into the ground, into a footing, or into a foundation and the wall section 102 is attached to the columns or rods by mechanical fasteners. One preferred method of supporting wall section 102 when bulkhead 100 is used to retain soil, sand, or stone and the like is to provide one or more ballasts 110. Ballasts 110, which may be attached to the wall section 102 by rods 112, can be buried within the material being retained by wall 100, for example, soil, so that ballasts 110 provide a secure restraint for bulkhead 100. Rods 112 which secure wall section 102 to ballasts 110 are typically threaded steel rods. Rods 112 are typically attached to wall section 102 by means of mechanical fasteners, for instance, nuts and bolts. For example, as shown in FIG. 16, rods 112 pass through wall section 102 and are secured to the opposite side of the wall section 102 by means of bolt heads or nuts 114 and washers 116. The rods 112 may be secured to wall section 102, but are preferably secured to beams 106 to provide a more rigid connection to wall section 102. As also shown in FIG. 16, rods 112, bolt heads or nuts 114, and washers 116 may also be the means by which cross beams 106 are attached to wall section 102. Rods 112 are typically attached to ballasts 108 using nuts and washers (not shown) located on the back side of ballasts 108 in a similar fashion.

Thus the present invention provides structural members, and methods of fabricating structural members having improved structural integrity and which can be more easily manufactured compared to prior art methods.

While the invention has been particularly shown and described with reference to preferred embodiment, it will be understood by those skilled in the art that various changes in form and details may be made to the invention without departing from the spirit and scope of the invention described in the following claims.

1. A method for fabricating structural materials from tires, comprising:
removing side walls from the tires;
cutting the tires in a transverse direction to provide elongated strips of tire material having at least some inherent curvature;
treating the strips to remove at least some of the inherent curvature;
mating at least two of the strips with an adhesive; and
bonding the strips and adhesive to produce the structural material.

2. The method as described in claim 1, wherein the treating comprises compressing and heating the strip to remove at least some of the inherent curvature.

3. The method as recited in claim 2, wherein the compressing is practiced to provide a pressure of at least 100 psi and the heating is practiced at greater than 100 degrees F.

4. The method as recited in claim 3, wherein the heating is practiced at greater than 200 degrees F.

5. The method as recited in claim 4, wherein the heating is practiced at between about 200 and about 300 degrees F.

6. The method as recited in claim 1, wherein the bonding comprises compressing and heating the strips and adhesive.

7. The method as recited in claim 6, wherein the compressing is practiced to provide a pressure of at least 100 psi and the heating is practiced at greater than 100 degrees F.

8. The method as recited in claim 7, wherein the heating is practiced at greater than 200 degrees F.

9. The method as recited in claim 8, wherein the heating is practiced at between about 200 and about 300 degrees F.

10. The method as recited in claim 1, further comprising removing at least some tread from the tires.

11. The method as recited in claim 10, wherein the removing of at least some of the tread comprises an abrasion process.

12. The method as recited in claim 11, wherein the abrasion process is buffing.

13. The method as recited in claim 1, wherein the tires includes at least one reinforcing bead and the method further comprises removing the reinforcing bead.

14. The method as recited in claim 1 wherein the steps of the method are practiced sequentially.

15. The method as recited in claim 1 further comprising sorting the tires by size and physical condition.

16. The method as recited in claim 1, wherein the tires are used tires.

17. The method as recited in claim 16, wherein the tires are used vehicle tires.

18. A structural member, fabricated from tires, the method comprising:
removing side walls from the tires;
cutting the tires in a transverse direction to provide elongated strips of tire material having at least some inherent curvature;
treating the strips to remove at least some of the inherent curvature;
mating at least two of the strips with an adhesive; and
bonding the strips and adhesive to produce the structural material.

19. The structural member as recited in claim 18, wherein the structural member is one of a plank, a board, a beam, a rod, a tube, an arch, a column, a post, a stud, roofing, and flooring.

20. The method as described in claim 18, wherein the treating comprises compressing and heating the strip to remove at least some of the inherent curvature.

21. The method as recited in claim 20, wherein the compressing is practiced to provide a pressure of at least 100 psi and the heating is practiced at greater than 100 degrees F.

22. The method as recited in claim 18, wherein the bonding comprises compressing and heating the strips and adhesive.

23. The method as recited in claim 22, wherein the compressing is practiced to provide a pressure of at least 100 psi and the heating is practiced at greater than 100 degrees F.

24. A method for fabricating structural materials from tires, comprising:
removing side walls from the tires by cutting the side walls at a point below the tread;
removing at least some tread material from the tires to provide an essentially uniform tread thickness;
cutting the tires in a transverse direction to provide elongated strips of tire material having at least some inherent curvature;
removing at least some of the inherent curvature by compressing the strips to at least about 100 psi and heating the strips to at least 200 degrees F. to remove at least some of the inherent curvature;
mating at least two of the strips with a gum rubber adhesive; and
bonding the strips and gum rubber adhesive by compressing the strips and gum rubber adhesive to at least about 100 psi and heating the strips and gum rubber adhesive to at least 200 degrees F. to produce the structural material.

25. The method as recited in claim 24, wherein the heating during removing at least some of the inherent curvature is practiced at between about 200 and about 300 degrees F.

26. The method as recited in claim 24, wherein the removing of at least some of the tread comprises an abrasion process.

27. The method as recited in claim 24, wherein the tires include at least one reinforcing bead and the method further comprises removing the reinforcing bead.

28. The method as recited in claim 24 wherein the steps of the method are practiced sequentially.

29. A method for fabricating structural materials from tires, comprising:
removing side walls from the tires;
cutting the tires in a transverse direction to provide elongated strips of tire material having at least some inherent curvature;
treating the strips to remove at least some of the inherent curvature;
mating at least two of the strips with an adhesive; and
in a process distinct from the treating, bonding the strips and adhesive to produce the structural material.

30. The method as described in claim 29, wherein the treating comprises compressing and heating the strip to remove at least some of the inherent curvature.

31. The method as recited in claim 30, wherein the compressing is practiced to provide a pressure of at least 100 psi and the heating is practiced at greater than 100 degrees F.

32. The method as recited in claim 31, wherein the heating is practiced at greater than 200 degrees F.

33. The method as recited in claim 32, wherein the heating is practiced at between about 200 and about 300 degrees F.

34. The method of claim 1, wherein bonding is practiced distinct from the step of treating the strips to remove at least some of the inherent curvature.

35. The structural member as recited in claim 18, wherein bonding is practiced distinct from the step of treating the strips to remove at least some of the inherent curvature.

36. The method of claim 24, wherein bonding is practiced distinct from the step of treating the strips to remove at least some of the inherent curvature.
